(19) United States
(12) Patent Application Publication
(10) Pub. No.: US 2015/0115123 A1
(43) Pub. Date: Apr. 30, 2015

(54) FOLDABLE AND PORTABLE MUSIC STAND

(71) Applicant: Wai Ho NG, North Point, Hong Kong (CN)

(72) Inventor: Wai Ho Ng, Hong Kong (CN)

(21) Appl. No.: 14/390,257

(22) PCT Filed: Jul. 12, 2013
(86) PCT No.: PCT/CN2013/079314

§ 371 Date: Oct. 2, 2014

(30) Foreign Application Priority Data
Jul. 12, 2012 (CN) 201220336685.3

(51) Int. Cl. F16M 11/28; F16M 11/24; G10G 7/00; F16M 11/16

(52) U.S. Cl. CPC F16M 11/28; F16M 11/16; F16M 11/242; G10G 7/00
USPC 248/451; 248/462

(57) ABSTRACT

A foldable and portable music stand (100) comprising: a music platform (102) for placing a music score and a music book; a pole comprising a main pole (106), a second pole (108), and a third pole (110); a foldable arm; and a support stand. The second pole (108) is sleeved in the main pole (106) in a sliding vertical adjustment manner; the third pole (110) is sleeved in the second pole (108) in a sliding vertical adjustment manner; the foldable arm is pivotally disposed at the top of the third pole (110); a locking ring (114) is disposed at the top of the main pole (106), so as to selectively lock the position of the second pole (108); a locking ring (116) is disposed at the top of the second pole (108), so as to selectively lock the position of the third pole (110); the music platform (102) is detachably connected to the foldable arm; a hollow groove is disposed on the surface of the foldable arm opposing the main pole (106); the hollow groove is slightly larger than the main pole (106), so that the main pole (106) can be nested in the hollow groove when the foldable portable music stand (100) is folded; the support stand is a foldable supporting base (118), is connected to a ferrule set (112) disposed at the bottom of the main pole (106) via a hinge, and can pivot between an unfolded position and a position adjacent to the main pole (106).

### FIELD OF THE INVENTION

The present invention generally relates to accessories and instruments for musical performance, and particularly to a foldable and portable music stand.

### BACKGROUND OF THE INVENTION

Till now, traditional foldable and portable music stands for placing music scores and music books are normally consisted of many components connected with each other by virtue of movable joints. Thus, such music stands are very heavy. In addition, many procedures are needed to completely open such music stands consisted of many movable joints from their folded state, and vice versa. Thus, such music stands are subject to ageing and damage.

A U.S. Pat. No. 7,258,320 B2 (publication No. US2006/0175523 A1) disclosed a foldable and portable music stand. Although the invention satisfies the requirements for foldability and portability, the music stand of this invention is still consisted of many components and many movable joints, to realize the function of placing music scores. Thus, technical effect of this music stand is not desirable, and is still subject to ageing and damage. Besides, many procedures are still needed to completely fold or open this kind of music stand, and thus it is not convenient for users.

Another U.S. design Pat. No. 557,035 S1 also disclosed a foldable and portable music stand. The design focuses on foldability and portability of the music stand. However, the design is also consisted of many movable joints and is also susceptible to ageing and damage. Furthermore, a music platform of the music stand has a foldable frame structure, and most part of a back of the music platform is hollow which makes the back not suitable for holding relatively small music score displays, such as electronic music score devices or tablet computers. Such small music score displays are susceptible to destroy due to falling down to the ground from the hollow of the back.

### SUMMARY OF THE INVENTION

The present invention aims to provide a foldable and portable music stand, in which a music platform of the music stand is detachable with respect to a main body thereof, and the main body has a telescopic structure which could dramatically reduce the overall volume of the music stand after being folded completely. Thus, it is convenient for transportation and storage. At the same time, the detached music platform could also be used an independent folder for placing music scores or music books.

To achieve the above object, the present invention provides a foldable and portable music stand, which may comprise: a music platform for placing music scores and music books; a shaft including a main shaft, a second shaft, a third shaft and a foldable arm, in which the second shaft is provided within the main shaft and movable up and down along the latter; the third shaft is provided within the second shaft and movable up and down along the latter; the foldable arm is pivotally mounted on a top of the third shaft; a locking ring is provided at a top of the main shaft to enable to selectively lock the second shaft with respect to the main shaft; a locking ring is provided at a top of the second shaft to enable to selectively lock the third shaft with respect to the second shaft; the music platform is detachably connected to the foldable arm; a receiving groove is formed on a surface of the foldable arm facing to the main shaft, and the size thereof is slightly bigger than that of the main shaft to enable the main shaft to be received in the receiving groove when the foldable and portable music stand is in a folded state; and a support stand being foldable legs connected to a collar assembly provided at a bottom of the main shaft by virtue of pivots, to enable to be pivoted between a stretched state and a state when the foldable legs rest on the main shaft.

Preferably, an aperture may be formed in a lower middle part of the music platform, and the size thereof is substantively the same as that of the foldable arm to enable to be sleeved on the foldable arm; the aperture is provided with tenons at both sides the aperture along its height; the foldable arm is provided with matching slots at both sides of the foldable arm along its height; the tenons are inserted into the slots when the music platform is sleeved on the foldable arm.

Preferably, the foldable arm is pivotally mounted on a top of the third shaft by virtue of a lockable pivot; a locking handle is provided with the lockable pivot to enable to lock the foldable arm at various degrees with respect to other parts of the shaft.

Preferably, the elastic strips are respectively provided to the music platform at two outer corners of the latter, to enable to fix music scores or music books.

The technical effects of the present invention are as follows:

1. The present invention could realize a kind of music stand with very high foldability. The number of components adopted in the present music stand is less than that of other foldable music stands, and it needs fewer procedures for completely folding or opening the present music stand. Thus, the risk of damage or ageing of the present music stand is lower than those in the prior arts;
2. The present invention could realize a kind of music stand with very high portability. Fewest components are adopted in the present music stand, in which lager components such as the music platform are detachable from the main body of the music stand, and then could be used as a useful folder. In this way, the overall weight and volume of the present music stand could be reduced after being folded. Furthermore, various uses of the components of the present music stand could be adapted effectively and sufficiently, to enhance the portability thereof;
3. Another high efficient foldable solution realized by the present invention is to adapt the engagement of tenons and slots, which could fix the music platform to the main body of the music stand easily and stably. As no mechanical components are involved, the risk of damage or ageing of the present music stand is lower than those in the prior arts;
4. The present invention could realize a kind of music stand with very high usability. Due to its excellent foldability and portability, users are encouraged to use it in various situations and sites.
5. The present invention could realize a kind of music stand with very high usability. Since few movable joints are involved, the risk of damage or ageing of the components of the present invention is relatively lower than the traditional products in the prior arts, and thus its service life is relatively higher than the traditional products in the prior arts;
6. The present invention could realize a kind of music stand with very high flexibility. The music platform is fixed to the main body of the music stand adeptly by means of engagement of tenons and slots. Such technical solution could be developed to form many different technical solutions of music platform, to be suitable for different interfaces of music scores, such as tablet computers, etc.;
7. The present invention could realize significant aesthetic flexibility. Since the music platform is detachable from the main body of the music stand, a music stand could be suitable for more than one kind of music platforms. Since the music platforms could possess countless appearances by designed differently, the artistic and aesthetic flexibility of the whole music stand could be enhanced.

### BRIEF DESCRIPTION OF THE DRAWINGS

The present invention will be described in details with reference to the accompanying drawings. The figures are for illustration purposes only and are not drawn to scale, in which:

FIG. 1 is a side perspective view of the foldable and portable music stand according to the present invention;

FIG. 2 is a front view of the foldable and portable music stand according to the present invention;

FIG. 3 is a right side view of the foldable and portable music stand according to the present invention;

FIG. 4 is a left side view of the foldable and portable music stand according to the present invention;

FIG. 5 is a rear view of the foldable and portable music stand according to the present invention;

FIG. 6 is a front view of the foldable and portable music stand according to the present invention, in which a music platform is detached from a main body of the foldable and portable music stand;

FIG. 7 is an enlarged view of the music platform of the foldable and portable music stand according to the present invention;

FIG. 8 is an enlarged view of a foldable arm of the foldable and portable music stand according to the present invention;

FIG. 9 is a top view of the foldable and portable music stand according to the present invention;

FIG. 10 is a bottom view of the foldable and portable music stand according to the present invention;

FIG. 11 is a rear view of the foldable and portable music stand according to the present invention after being folded completely;

FIG. 12 is a right side view of the foldable and portable music stand according to the present invention after being folded completely;

FIG. 13 is a left side view of the foldable and portable music stand according to the present invention after being folded completely;

FIG. 14 is a top view of the foldable and portable music stand according to the present invention after being folded completely;

FIG. 15 is a bottom view of the foldable and portable music stand according to the present invention after being folded completely.

### DETAILED DESCRIPTION OF THE INVENTION

The present invention would be further described herein with reference to the accompanying drawings and embodiments of the present invention.

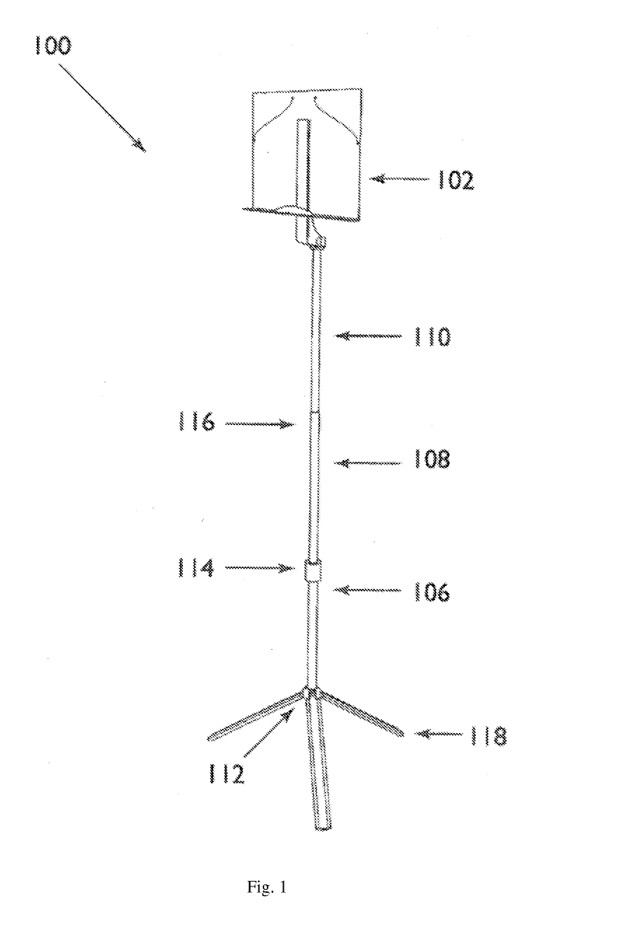

FIG. 1 is a side perspective view of the foldable and portable music stand 100 according to the present invention. The foldable and portable music stand could be folded to a compact unit, to enable to transport and store and to avoid damage during transportation. The present foldable and portable music stand provides a firm music platform 102 for musicians. Music scores and music books could be placed on the music platform 102. A main shaft 106 is connected to a collar assembly 112 at its bottom, and foldable legs 118 are connected to the collar assembly 112 by virtue of pivots mounted in the collar assembly 112. In addition, a second shaft 108 is provided within the main shaft 106 and movable up and down along the latter. A top of the main shaft 106 is provided with a locking ring 114 to enable to lock the second shaft 108 with respect to the main shaft 106. A third shaft 110 is provided within the second shaft 108 and movable up and down along the latter. A top of the second shaft 108 is provided with a locking ring 116 to enable to lock the third shaft 110 with respect to the second shaft 108.

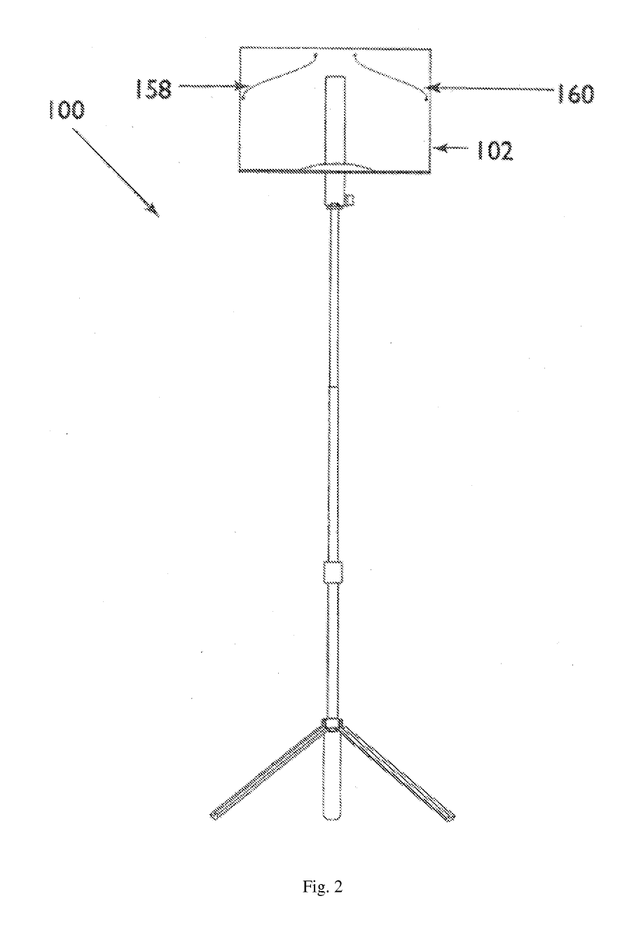

FIG. 2 is a front view of the foldable and portable music stand 100 according to the present invention. As shown in FIG. 2, elastic strips 158 and 160 are respectively connected to the music platform 102 at two outer corners of the latter, to enable to fix music scores or music books.

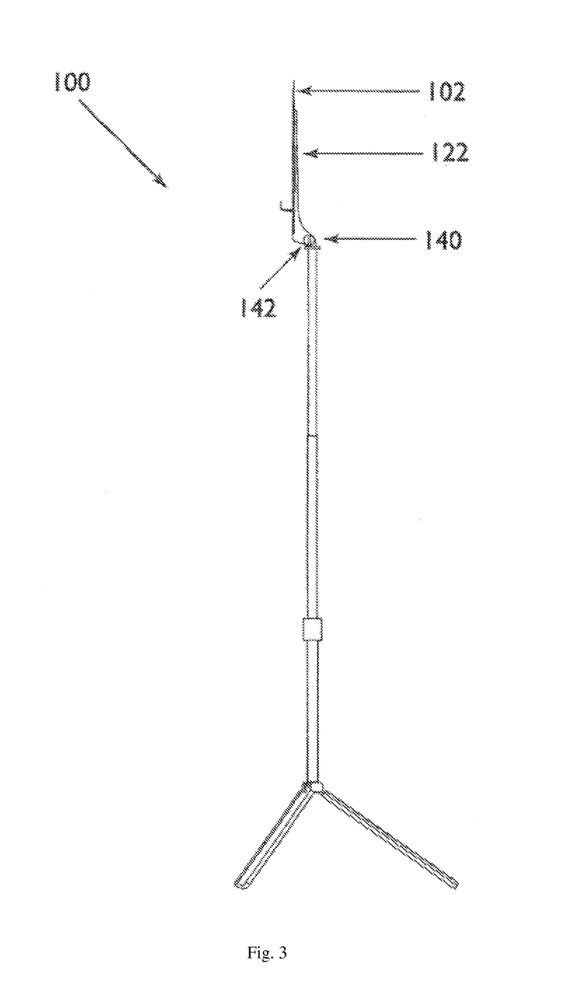

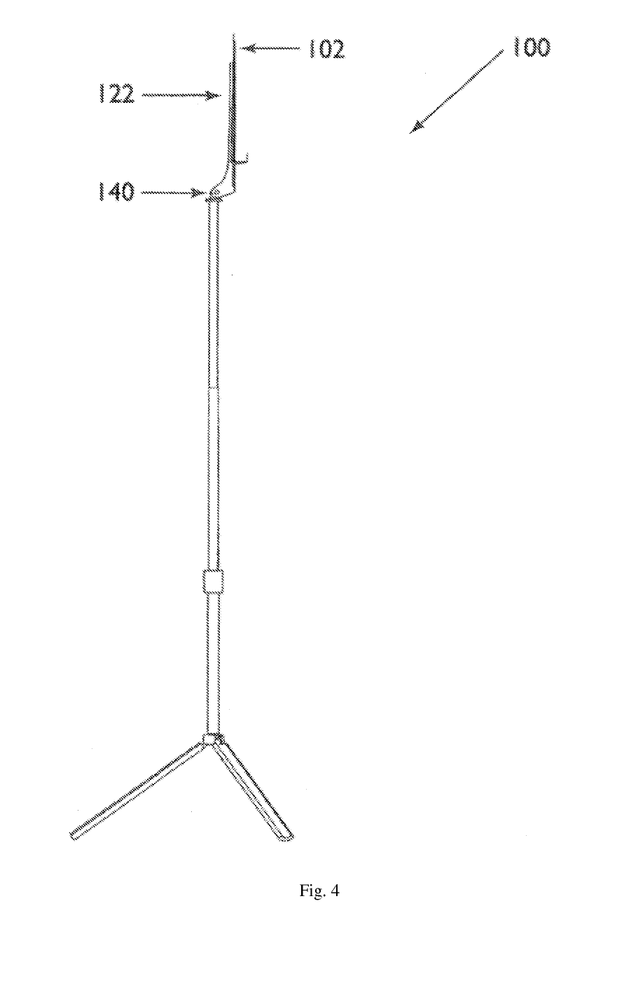

FIGS. 3-5 are the right side view, left side view and rear view of the foldable and portable music stand 100 according to the present invention respectively. As shown in the figures, the music platform is attached to a foldable arm 122, and the foldable arm 122 is pivotally mounted on a top of the third shaft 110 by virtue of a lockable pivot 140. By means of a locking handle 142 of the lockable pivot 140, the foldable arm 122 could be locked at various degrees with respect to the main body of the foldable and portable music stand 100. Thus, the music platform 102 and the music score thereon could also be positioned at various degrees with respect to the main body of the foldable and portable music stand for the convenience of users.

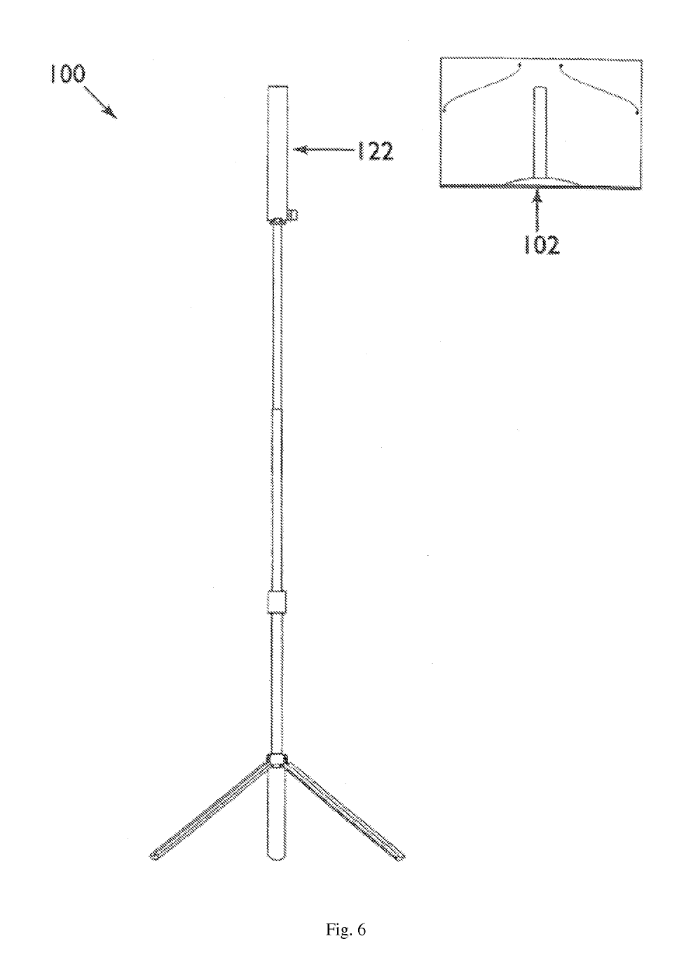

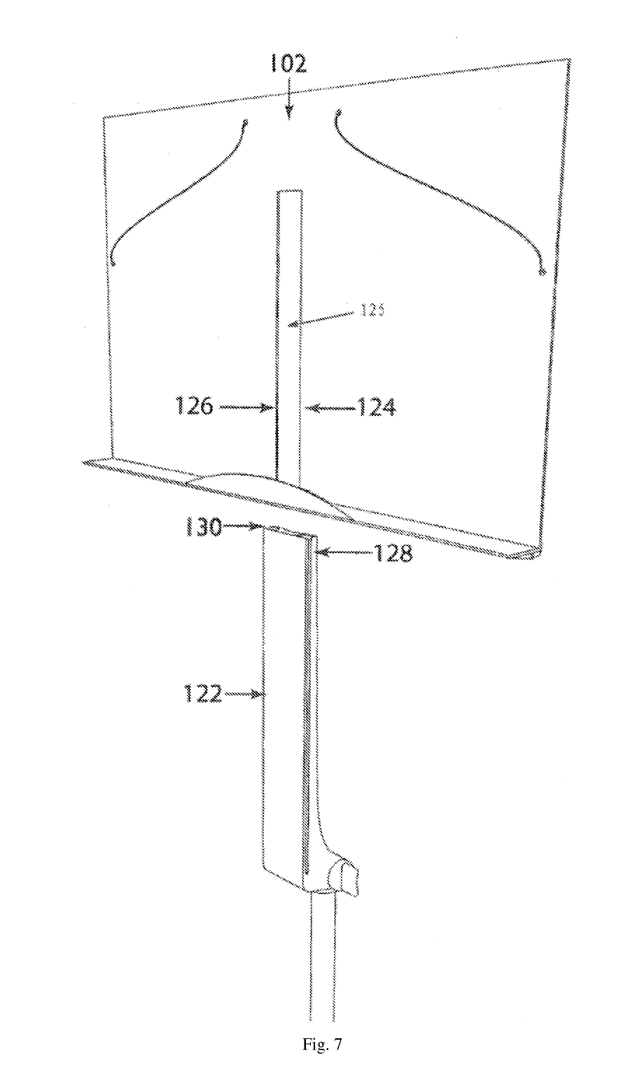

FIG. 6 is the front view of the foldable and portable music stand 100 according to the present invention, in which the music platform is detached from the main body of the foldable and portable music stand; while FIG. 7 is the enlarged view of the music platform of the foldable and portable music stand according to the present invention. As shown in FIG. 7, an aperture 125 is formed in the lower middle part of the music platform 102, and the size thereof is substantively the same as that of the foldable arm 122, to enable to be sleeved on the foldable arm 122. The aperture 125 is provided with tenons 124 and 126 at both sides of the aperture along its height. Correspondingly, the foldable arm 122 is provided with matching slots 128 and 130 at both sides of the foldable arm along its height. When the music platform 102 is sleeved on the foldable arm 122, the tenons 124 and 126 are inserted into the slots 128 and 130 respectively, and thus the music platform 102 is detachably mounted on the foldable arm 122.

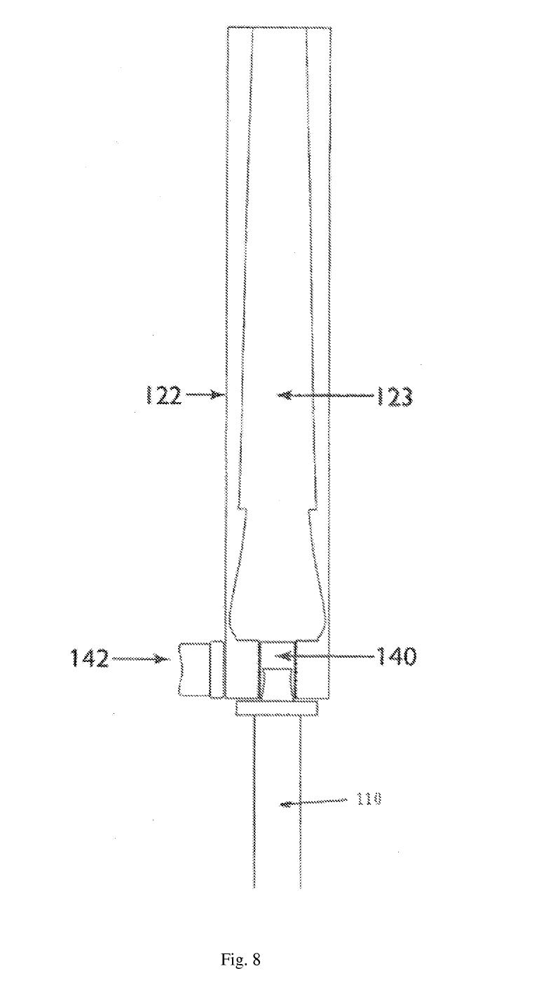

FIG. 8 is the enlarged view of the foldable arm 122 of the foldable and portable music stand 100 according to the present invention. As shown in the figure, a receiving groove 123 is formed on a surface of the foldable arm 122 facing to the third shaft 110, and the size thereof is slightly bigger than that of the main shaft 106, to enable the main shaft 106 to be received in the receiving groove 123 when the present foldable and portable music stand 100 is in a folded state, which could make the folded foldable and portable music stand to be more compact.

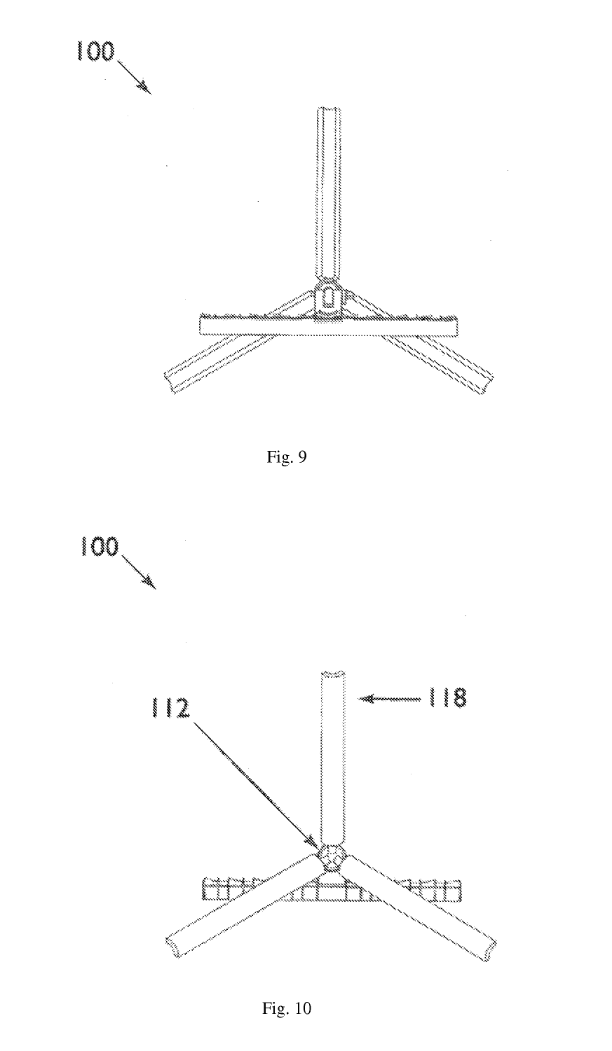

FIGS. 9 and 10 are the top view and bottom view of the foldable and portable music stand according to the present invention. The foldable legs 118 are connected to a bottom of the collar assembly 112 by virtue of the pivots mounted in the collar assembly 112, to enable to be pivoted with respect to the pivots between a stretched state and a folded state. In the folded state, the foldable legs 118 rest on the main shaft 106.

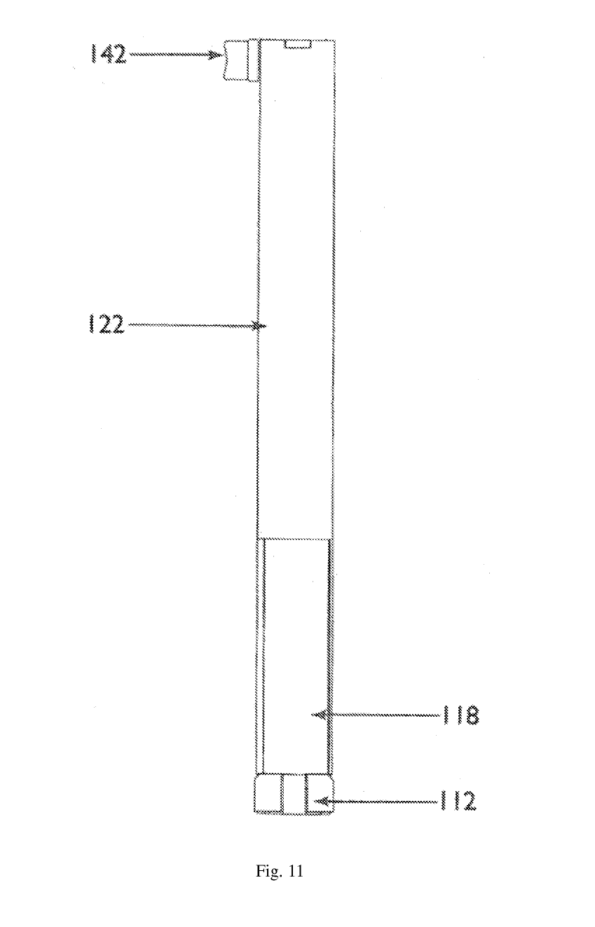

FIG. 11-15 is a state when the foldable and portable music stand of the present invention is folded completely.

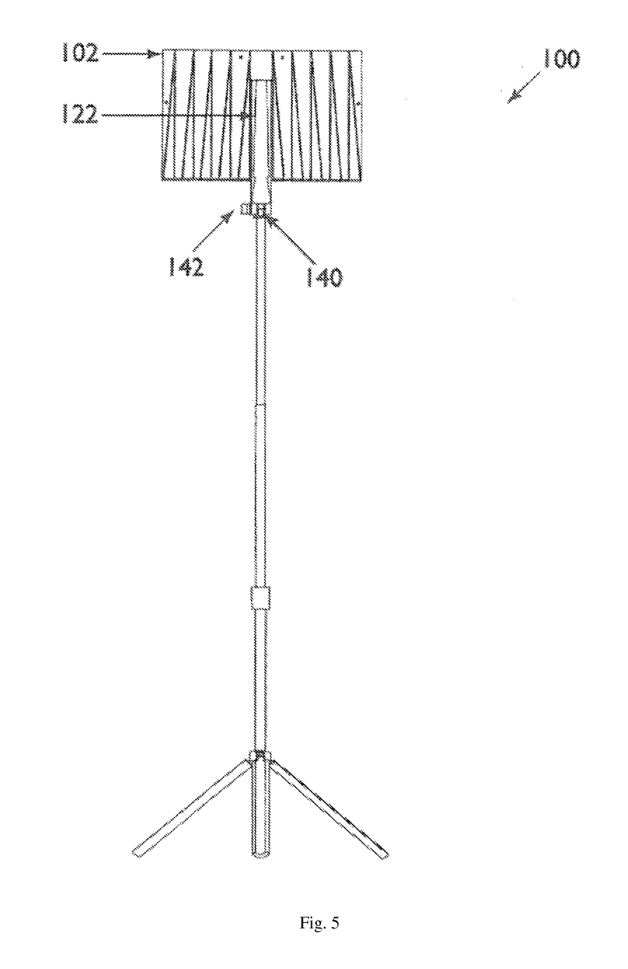

As shown in FIG. 11, the foldable arm 122 is rotated towards to the main shaft 106 by adjusting the lockable pivot 140 (see FIG. 5) and locking handle 142, until the main shaft 106 is received in the receiving groove 123. Then, the locking handle 142 is fastened, to keep the foldable arm 122 in the folded state. In addition, the foldable legs 118 are rotated towards the main shaft 106, until rest on the latter in the folded state. Thus, the foldable and portable music stand 100 is folded into a very compact unit.

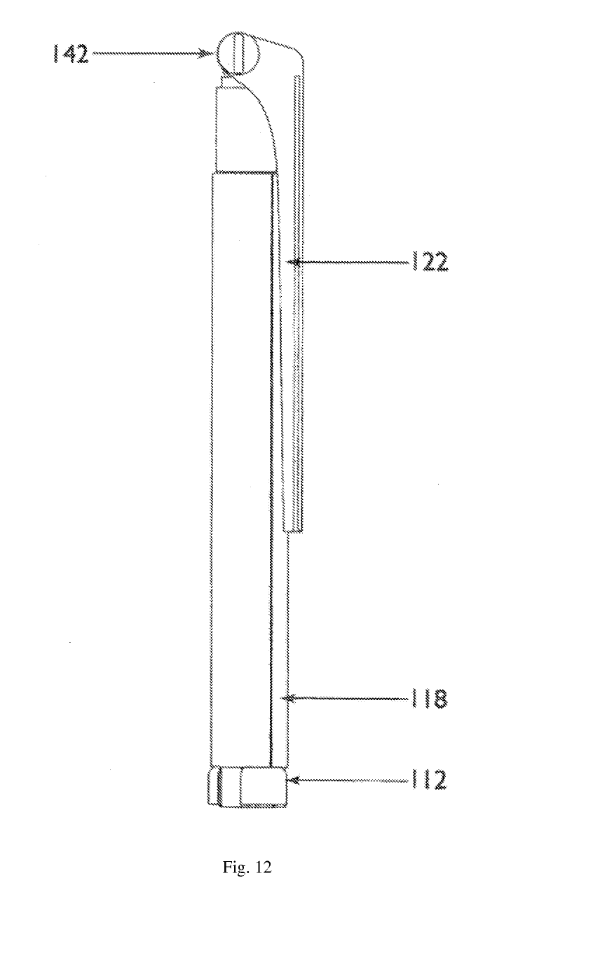

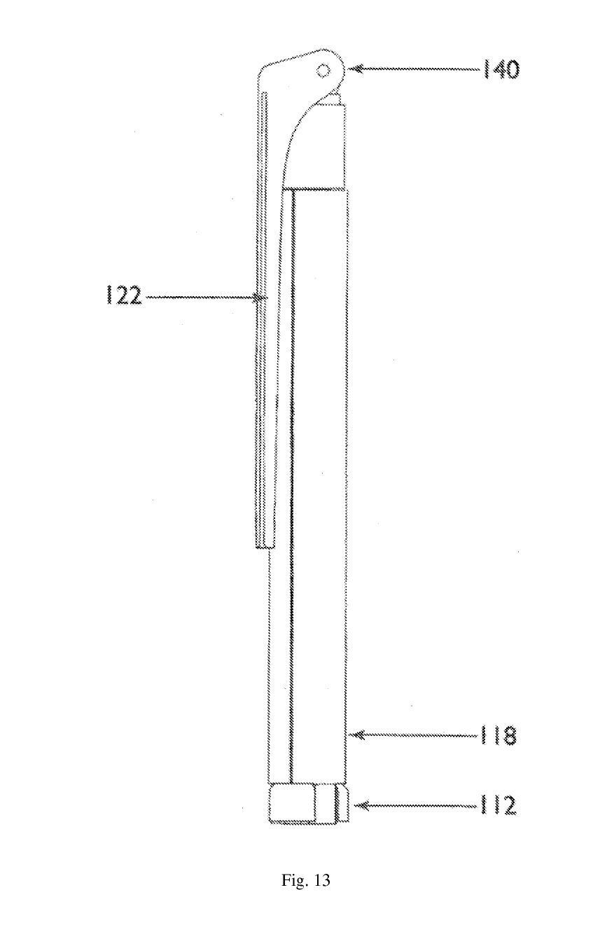

FIGS. 12 and 13 are the right side view and left side view of the foldable and portable music stand according to the present invention after being folded completely. As shown in the figures, the foldable arm 122 is rotated to a substantively vertical position, and finally close to the main shaft 106 and foldable legs 118, to realize a completely folded state. The locking handle 142 then locks the lockable pivot 140, to prevent the foldable arm 122 from rotating.

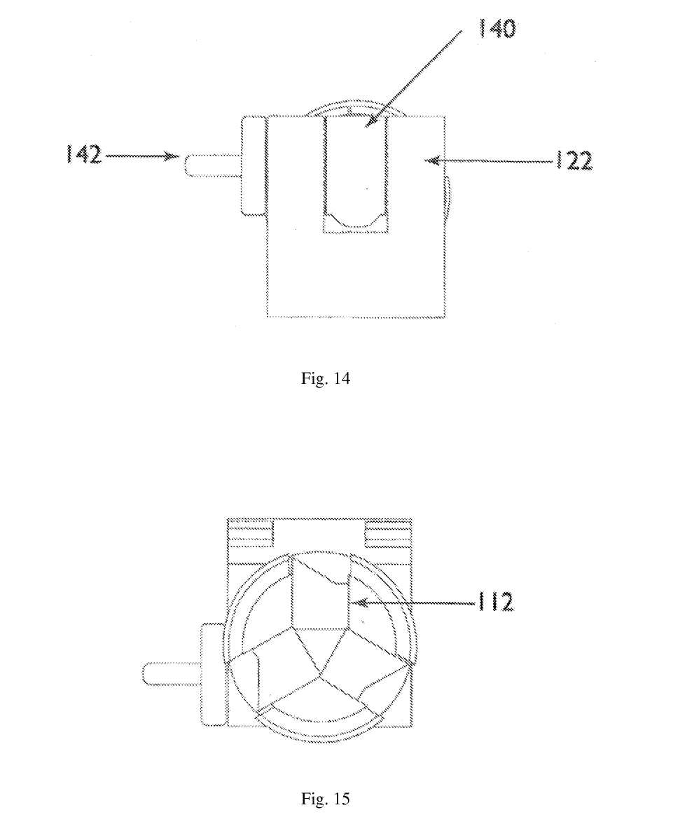

FIGS. 14 and 15 are the top view and bottom view of the foldable and portable music stand according to the present invention after being folded completely, in which FIG. 14 illustrates that the foldable arm 122 is pivotally connected to the lockable pivot 140, while FIG. 15 illustrates the pivots by which the foldable legs are pivotally connected to the collar assembly 112.

The present invention provides the foldable and portable music stand 100, and its music platform 102 is detachable from the foldable arm 122. After the music platform 102 is detached, it could also be used as a semi-open folder for placing music scores or music books, which could be stored in a user's bag just like a common folder. In addition, the rest of the present foldable and portable music stand 100 except for the detached music platform could be folded into a very compact unit, to lower its size and weight for the convenience of transportation and storage.

1.-4. (canceled)

5. A foldable and portable music stand comprising:
a music platform for placing music scores and music books;
a shaft including a main shaft, a second shaft, a third shaft and a foldable arm, in which the second shaft is provided within the main shaft and movable up and down along the latter; the third shaft is provided within the second shaft and movable up and down along the latter; the foldable arm is pivotally mounted on a top of the third shaft; a locking ring is provided at a top of the main shaft to enable to selectively lock the second shaft with respect to the main shaft; a locking ring is provided at a top of the second shaft to enable to selectively lock the third shaft with respect to the second shaft; the music platform is detachably connected to the foldable arm;
a receiving groove is formed on a surface of the foldable arm facing to the main shaft, and the size thereof is slightly bigger than that of the main shaft to enable the main shaft to be received in the receiving groove when the foldable and portable music stand is in a folded state;
a support stand being foldable legs connected to a collar assembly provided at a bottom of the main shaft by virtue of pivots, to enable to be pivoted between a stretched state and a state when the foldable legs rest on the main shaft.

6. The foldable and portable music stand of claim 5, wherein an aperture is formed in a lower middle part of the music platform, and the size thereof is substantively the same as that of the foldable arm to enable to be sleeved on the foldable arm; the aperture is provided with tenons at both sides of the aperture along its height; the foldable arm is provided with matching slots at both sides of the foldable arm along its height; the tenons are inserted into the slots when the music platform is sleeved on the foldable arm.

7. The foldable and portable music stand of claim 5, wherein the foldable arm is pivotally mounted on a top of the third shaft by virtue of a lockable pivot; a locking handle is provided with the lockable pivot to enable to lock the foldable arm at various degrees with respect to other parts of the shaft.

8. The foldable and portable music stand of claim 6, wherein the foldable arm is pivotally mounted on a top of the third shaft by virtue of a lockable pivot; a locking handle is provided with the lockable pivot to enable to lock the foldable arm at various degrees with respect to other parts of the shaft.

9. The foldable and portable music stand of claim 5, wherein elastic strips are respectively provided to the music platform at two outer corners of the latter, to enable to fix music scores or music books.

10. The foldable and portable music stand of claim 6, wherein elastic strips are respectively provided to the music platform at two outer corners of the latter, to enable to fix music scores or music books.
